(19) United States
(12) Patent Application Publication
(10) Pub. No.: US 2014/0122345 A1
(43) Pub. Date: May 1, 2014

(54) SHARING OF A RECEIPT AMONG MOBILE DEVICES

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/665,745

(22) Filed: Oct. 31, 2012

(51) Int. Cl. G06Q 30/04

(52) U.S. Cl. 705/304

(57) ABSTRACT

A method is disclosed for a customer sharing a receipt with other persons. An electronic receipt may be viewed on a mobile electronic device with electronic receipts software thereon. Using a device configured according to one or more embodiments of the invention, a customer is able to select the receipt for sharing as well as adding additional information to the receipt such as comments, ratings, reviews, etc. Information may be sent to a server or computer system to request that a receipt be shared with other persons. The server may then process the request and transmit receipt information to the contact person requested by the customer. The receipt may be shared via the contact person's mobile electronic device.

### BACKGROUND

1. Field of the Invention

This invention relates to receipts and receipt management systems and more particularly to an approach for allowing a customer to share a receipt with friends and other people.

2. Background of the Invention

Many point-of-sale (POS) systems currently in use today do not support important emerging technologies. For example, current POS systems are limited in their ability to handle electronic receipts and to facilitate management and sharing of receipts for transactions which generated electronic receipts. As a result, the adoption of electronic receipts is hindered or prevented by the inability to provide the functionality associated with a paper receipts or to adequately manage electronic receipts, and in particular for sharing receipts among users of different devices. Accordingly, what is needed is a system and method for facilitating use of electronic receipts in new novel ways. As will be seen, the invention provides such an approach in an elegant manner.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system having the capability to allow sharing of receipts among customers with mobile devices;

FIG. 2 is a schematic block diagram of one embodiment of multiple POS systems operating in the context of an enterprise-wide system;

FIG. 3 is a schematic block diagram of one embodiment;

FIG. 4 is a block diagram illustrating the flow of data within one embodiment;

FIG. 5 is a schematic block diagram of one embodiment of a receipt viewed on a mobile electronic device;

FIG. 6 is a schematic block diagram of one embodiment;

FIG. 7 is a block diagram of one embodiment of initializing a receipt sharing profile;

FIG. 8 is a block diagram of one embodiment of a method for sharing a receipt;

FIG. 9 shows schematic diagrams of various receipts according to one or more embodiments;

FIG. 10 is a block diagram illustrating the flow of data within one embodiment of system; and

FIG. 11 is a schematic block diagram of one embodiment of a receipts sharing module.

### DETAILED DESCRIPTION

It will be readily understood that the components of the embodiments, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, a novel approach is provided for managing receipts and in particular for sharing electronic receipts with friends and other persons.

In selected embodiments, a customer may utilize a mobile electronic device, such as a smart phone or tablet. An electronic receipt may be displayed or managed on the mobile electronic device and the device may include software which allows the customer to manage receipts and share receipts. The software may allow the customer to interface with the electronic receipt, with the POS system, and with a back office/supervisory receipts management system. Additionally, the electronic receipt software and/or the receipts management system may allow the customer to share receipts among other people such as among different users of mobile electronic devices. The customer may select contacts to share receipts with, and may initialize receipt sharing profiles which include one or more contacts and receipts may be shared with these persons.

The customer may make changes to the shared receipt, such as by only sharing particular items on the receipt while not sharing other items on the receipt. Additionally, the customer may make changes to the shared receipt such as including additional information on the receipt. The customer may add messages, ratings, reviews, etc. to the receipt and, more particularly, with regard to individual items on the receipt. These comments and additional information may be shared along with the shared receipt and, where appropriate, comments or information may be associated with a particular item on the receipt. Thus, a customer may share a receipt along with comments regarding the items on the receipt with friends, family, etc. The persons with whom the customer shared the receipt may also add additional information such as comments to the receipt and this additional information may be shared with the customer and with other persons who have a shared copy of the receipt. In this manner, a shared receipt may be updated within a group of people as these people add information to the receipt.

Various parts of a receipts management system may facilitate communication with the customer and others and may allow the customer to share receipts among other persons. Various parts of a receipts management system are described to illustrate how these may allow a customer to manage electronic receipts, and more particularly to share receipts among other people. In certain embodiments, a machine-readable code may be used to interact between the customer's mobile electronic device, receipts, a receipts management server, and/or the POS system. The machine readable code may comprise a conventional barcode or a two-dimensional barcode (e.g., a Quick Response (QR) Code). The data encoded within a machine-readable code may vary between different embodiments and different purposes or goals of the embodiment. In selected embodiments, a machine-readable code may encode a transaction identification (ID) uniquely identifying a particular transaction (e.g., purchase, return, or the like). Alternatively, or in addition thereto, a machine-readable code may encode data regarding the POS terminal and/or the store where the terminal is located. A machine readable code may facilitate the installation of electronic receipts software by the customer or other persons known to the customer. In some embodiments, a machine readable code may be accompanied by an alpha-numeric code.

In general, the purpose of a receipts system is to facilitate the handling of receipts in a manner which is convenient to the customer and which also provides a desired measure of security. Many challenges arise in using electronic receipts. In particular, the use of electronic receipts may create challenges when a customer needs to perform subsequent receipt management functions such as sharing receipts with friends or other persons.

Embodiments in accordance with the invention may be embodied as an apparatus, system, device, method, computer program product, or other entity. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of embodiments described herein may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

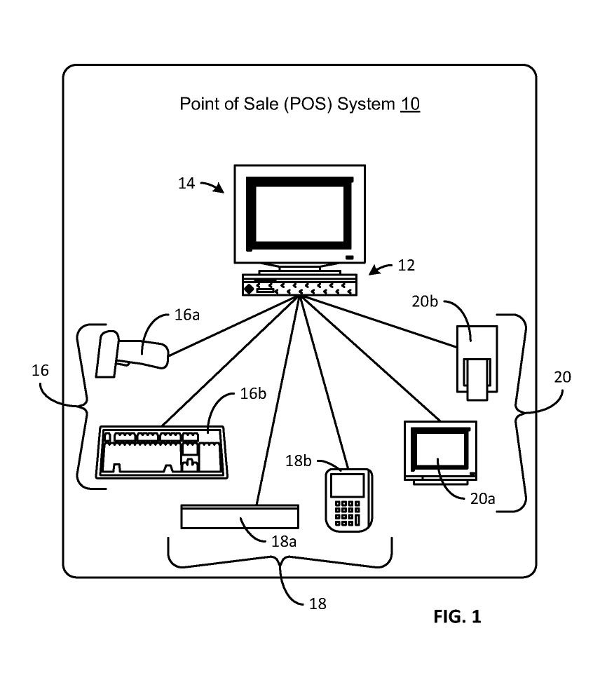

Referring to FIG. 1, in selected embodiments, the hardware, software, or hardware and software of a POS system 10 may be configured to implement one or more methods in accordance with embodiments described herein. For example, a POS system 10 may be manufactured, programmed, modified, or upgraded to support providing electronic receipts to customers and to facilitate subsequent management of the receipt. In particular, a POS system may allow a customer to provide receipt information to other persons such as work, an accountant, etc. In discussing the present system, it is appreciated that the system may involve one or more parts of a local POS terminal and associated computers or servers, remote computers or servers, customer devices such as a mobile electronic device, and associated equipment.

A POS system 10 may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 may include an accounting interface to pass certain information to one or more in-house or independent accounting applications. A POS system 10 may also communicate with third parties and may transmit receipt information and facilitate customer management of receipts.

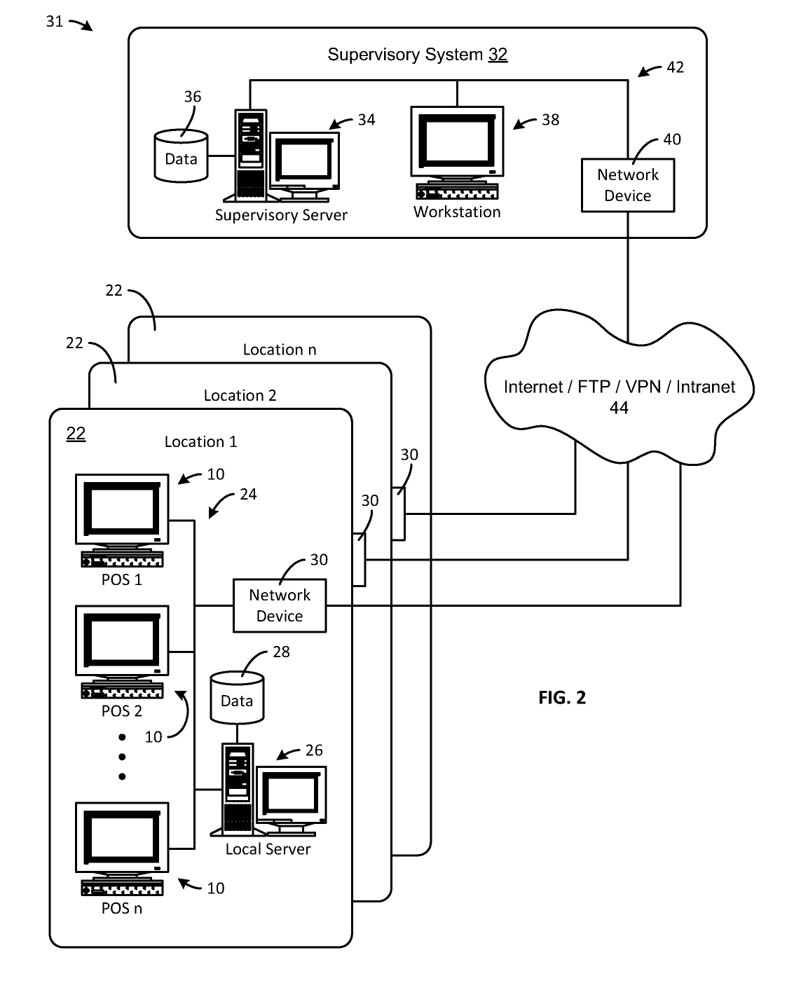

Referring to FIG. 2, in selected embodiments, a POS system 10 may operate substantially independently, as a stand-alone unit. Alternately, a POS system 10 may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system 32.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

It is thus appreciated that in discussing the functionality of the various POS terminals and servers, the embodiments described herein may be implemented in a system contained within a single location or across multiple locations. By way of example, the functionality accomplished by a server or computer, such as storing, processing, and transmitting/sending receipt information, may be accomplished by a local computer or a remote computer such as servers 26 and 34.

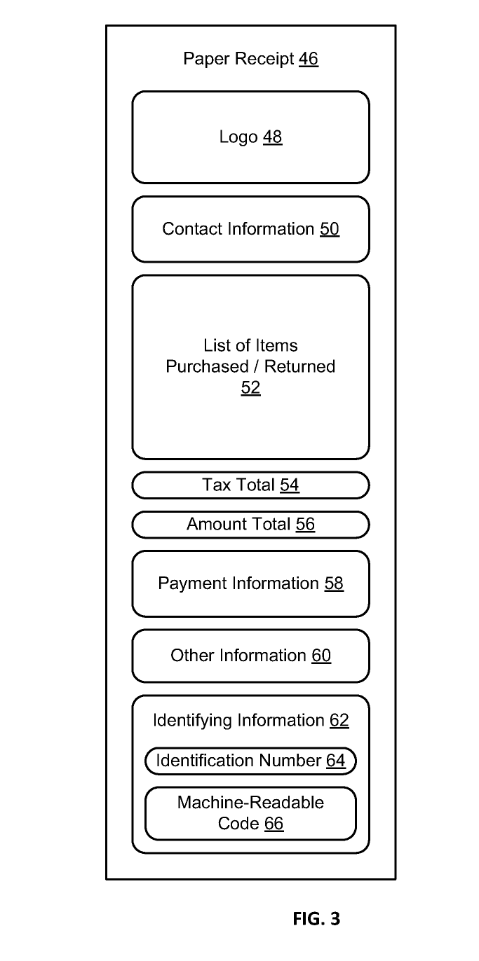

Referring to FIG. 3, in selected embodiments, a POS system 10 may output a receipt 46. For example, a printer 20b of a POS system 10 may output a paper receipt 46. A receipt 46 may perform various functions. Primarily, a receipt 46 may document a financial transaction (e.g., sale or return). In selected embodiments, a receipt 46 may include a logo 48, contact information 50, a list 52 of items purchased or returned, a total 54 indicating the sales tax assessed or returned, a total 56 indicating 56 the amount paid or returned, payment information 58, other information 60, or the like or combinations or sub-combinations thereof.

By including store contact information 50 on a receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within a receipt 46 as desired or necessary. In selected embodiments, a receipt 46 may include identifying information 62. Information 62 may include an identification number 64 which identifies the particular transaction associated with the receipt 46. Additionally, the identifying information 62 may include a machine-readable code 66. The code 66 may also provide information to identify the transaction associated with the particular receipt 46. The identifying information may include information such as the store where the items were purchased, the time of purchase, the total price of the transaction, etc.

A machine-readable code 66 may comprise a barcode. For example, in certain embodiments, a machine-readable code 66 may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode may follow any suitable protocol, format, or system. In selected embodiments, a two-dimensional code may be embodied as a Quick Response (QR) Code.

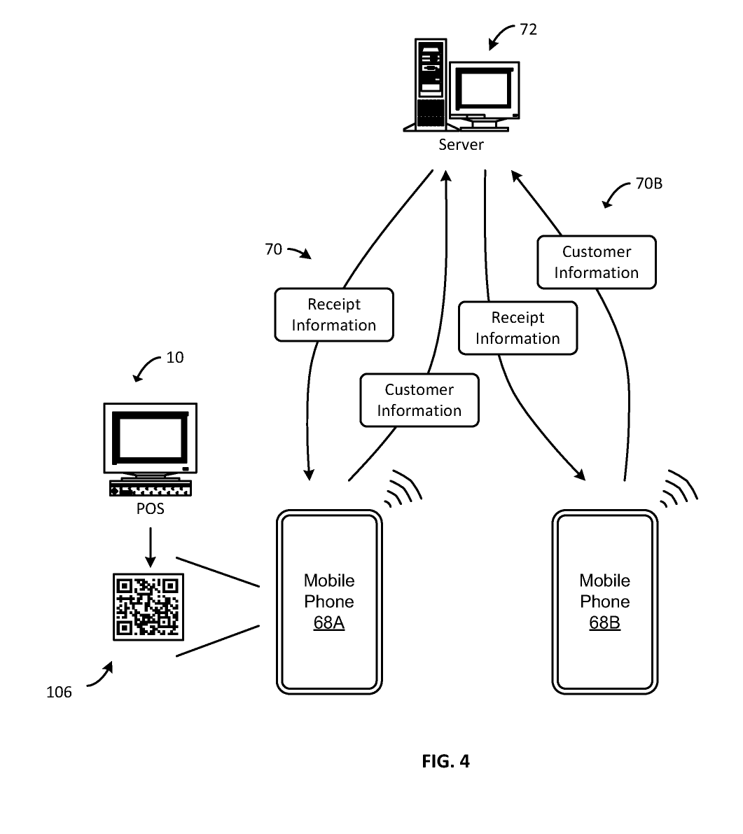

Referring to FIG. 4, a customer may download or may already have downloaded electronic receipts software to a mobile electronic device 68A. The mobile electronic device 68A may be a smart phone, tablet PC, etc. A customer may have previously received a paper receipt 46 which includes an invitation to use electronic receipts instead of paper receipts and may have installed electronic receipts software on the mobile electronic device 68A.

As indicated at 70, the customer may have an account with the computer server 72 and may transmit information to the server 72. It will be appreciated that the functionality of server 72 may be implemented by servers 26, 34, etc. The computer server 72 may likewise transmit information to the mobile device 68A. The customer may receive electronic receipts on the mobile device 68A and the electronic receipts software on the mobile device 68A may enable them to manage electronic receipts. Additionally, the electronic receipts software may allow the customer to interact with a POS system 10 via the mobile electronic device 68A.

In addition to the customer, one or more additional persons associated with the customer may have an electronic device 68B which has electronic receipts software. The receipts management software may allow the customer to share electronic receipts with other persons known to them. These other persons may have previously received a paper receipt 46 which includes an invitation to use electronic receipts instead of paper receipts and may have installed electronic receipts software on the mobile electronic device 68B.

Both the customer and the additional person(s) may have created an account with the receipts management server. The account may include a login such that the account is secure. The account and/or account creation process may facilitate verification of the person's identity and/or contact information, such as their email address or phone number. The account information may include a verified telephone number for a mobile electronic device.

Additionally, the customer may send an invitation to these other persons inviting them to download electronic receipts software, or may send a notification to these other persons that they desire to share a receipt with them and inviting them to download receipts management software and similarly create an account, etc. with the server 72 to allow them to manage electronic receipts in the manner discussed herein.

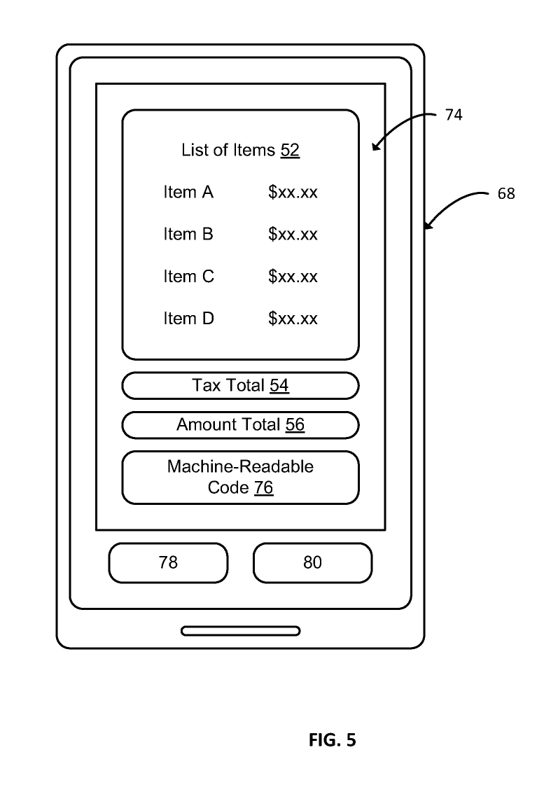

Referring to FIG. 5, the mobile electronic device 68A may display an electronic receipt 74 to the customer in a manner similar to the appearance of a paper receipt 46. The electronic receipts software on the mobile electronic device 68A allows a person to view their electronic receipts and to manage their receipts in many ways similar to a paper receipt. The software may provide menus, commands, or virtual buttons 78, 80 to the customer to facilitate completion of the various steps for managing electronic receipts which are discussed herein.

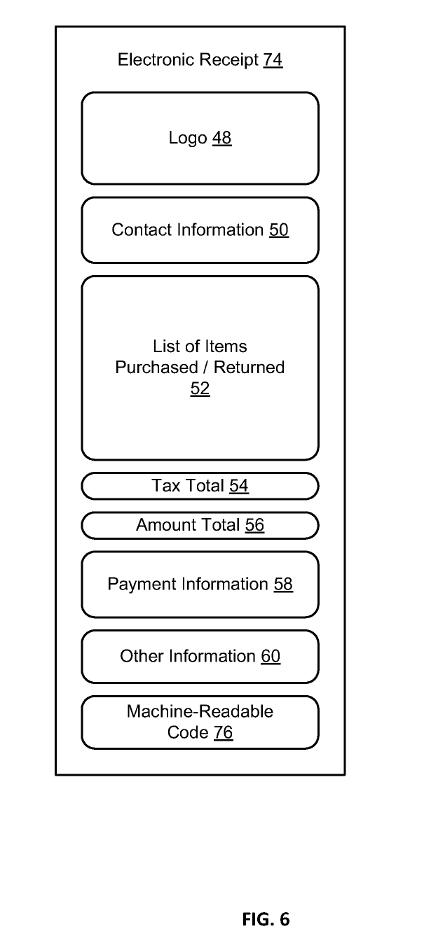

Referring to FIG. 6, the electronic receipt 74 is shown in greater detail. As discussed, a POS system 10 may output an electronic receipt 74 to a customer who has elected to receive an electronic receipt instead of a paper receipt. An electronic receipt 74 is often presented to a customer in a manner which is similar to a paper receipt 46. The electronic receipt 74 may include a store logo 48, contact information 50, a list 52 of items purchased or returned, a total 54 indicating the sales tax assessed or returned, a total 56 indicating 56 the amount paid or returned, payment information 58, a machine readable code 76 identifying the transaction, and other information 60 as desired, as well as combinations or sub-combinations thereof.

A machine-readable code 76 may comprise a barcode. For example, in certain embodiments, a machine-readable code 76 may comprise a conventional barcode or a two-dimensional barcode such as a QR code. Two-dimensional barcodes may support or provide more data per unit area than can be obtained using a traditional one-dimensional barcode. Moreover, two-dimensional barcodes are typically configured to be captured using a camera, an item that is commonly found on personal electronic devices. A two-dimensional barcode may follow any suitable protocol, format, or system. In selected embodiments, a two-dimensional code may be embodied as a Quick Response (QR) Code.

As regards the management of electronic receipts, the data encoded within a machine-readable code 76 may encode a transaction identification (ID). A transaction ID may uniquely identify a particular transaction (e.g., a transaction documented by a corresponding receipt 74). The machine-readable code 76 may include a data hash of desired information describing the purchase transaction. For example, the code 76 may contain the store and POS terminal where the transaction occurred, the time of the transaction, the total price of the transaction, etc. With such information, a receipt and associated transaction may be positively identified for management and further use of then receipt.

The use of electronic receipts may conserve natural resources by reducing the need for and consumption of paper. Electronic receipts may also enable a consumer to more easily track and manage his or her spending as well as share purchases with other persons. In some situations, a customer may desire to share a receipt with one or more other persons such as a friend, family member, etc. (often discussed herein simply as another person).

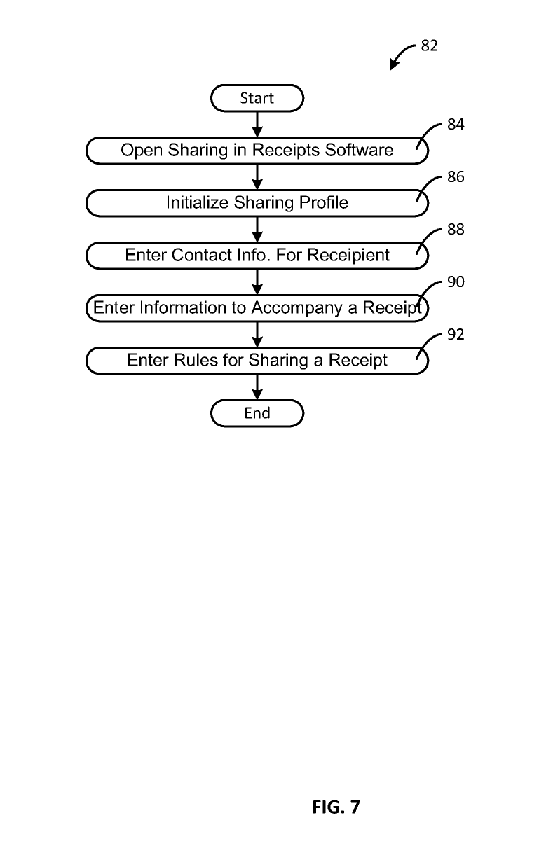

Referring to FIG. 7, a customer may use the electronic receipts software to manage their electronic receipts and more specifically to share a receipt with one or more other persons such as family or friends. FIG. 7 generally illustrates a process 82 which may be used to initialize the electronic receipts software to share receipts with another person or entity. The electronic receipts software may include a button for sharing, or may include a list or menu option for allowing a person to share a receipt. A customer may open 84 a sharing option within the electronic receipts software. The customer may then initialize 86 a sharing profile for one or more persons. The customer may enter 88 the name of a contact person to whom the shared receipts will be sent. Additionally, the customer may enter contact information 88 such as the person's email address or a telephone number for the person's mobile electronic device. Additionally, the electronic receipts software may allow the customer to enter information 90 to accompany the shared receipt. The customer may enter their contact information indicating who the receipt is from, etc. The customer may assign an avatar to associate with the sharing profile.

The customer may also enter rules 92 for sharing a receipt with the person. The customer may enter rules regarding which items are shared or which items are not shared with the person or persons associated with the sharing profile. The customer may create a ‘black list’ of items which are not shared with persons on the sharing profile and may create a ‘white list’ of items which are shared with persons on the sharing profile. The customer may create a rule to automatically share receipts with persons on the sharing profile or to prompt to share receipts with the sharing profile.

The electronic receipts software may allow the customer to initialize receipt sharing profiles by selecting contacts from contact information already stored on the mobile electronic device 68A. By way of example, the mobile electronic device may be a mobile telephone. As such, the mobile electronic device would typically have contact information for the customer's friends, family, etc. When the customer uses the electronic receipts software to initialize receipt sharing profiles, the electronic receipts software may ask the customer if they wish to share receipts with existing contacts which are stored on the mobile electronic device. If the customer elects to share receipts with a contact which is already on their electronic device 68A, the customer may select that contact while creating the receipt sharing profile. The electronic receipts software may then utilize available information from the contact and allow the customer to enter in any additional information which is necessary.

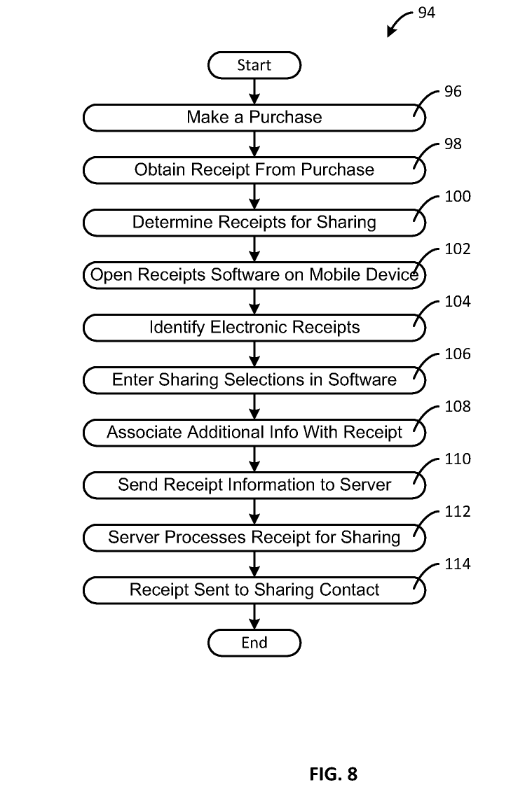

FIG. 8 generally illustrates a process 94 which may be used to share one or more items from a receipt with another person or entity. With electronic receipts software, the customer may have access to a receipt 46, 74 on their electronic device 68A. In order to make the receipts more usable to the customer, it is desirable to provide enhanced functionality as compared to simply providing the customer with an image of the receipt. The software may perform many functions allowing the customer to perform tasks such as reviewing receipts or sharing receipts.

Generally, a person will first make a purchase 96, typically at a local brick and mortar store. The purchase may include one or more items, and in some cases the purchase may include items which need to be shared and other items which do not need to be shared. After making a purchase, the customer will typically receive 98 a receipt. Where a customer has already elected to receive electronic receipts, the customer will typically receive an electronic receipt 74. The electronic receipt is typically sent to the customer's mobile electronic device from a receipts management server 72.

According to one embodiment, the electronic receipts software may ask the customer if they want to share the receipt with their work or another contact. If the customer has previously shared receipts for items which have now been purchased, the electronic receipts software may ask the customer if they want to share the current receipt with that receipt sharing profile. If the customer has set up a sharing profile for their family or friends, the electronic receipts software may ask them if they desired to share a receipt where that receipt contains items likely to be shared such as items similar to those previously shared.

A customer may determine 100 if they have any receipts for sharing. There may be many reasons why a customer would want to share a receipt. They may desire to share a receipt for a variety of reasons. The customer may desire to share receipts to provide purchase information to other persons. The customer may desire to share comments or other data related to items on the receipt. The customer may desire to share the receipt for budgeting purposes. If the customer needs to share a receipt, they may open 102 electronic receipts software on a mobile electronic device in order to manage their receipts. They may then identify 104 one or more electronic receipts for sharing. The person may enter 106 receipt sharing selections within the electronic receipts software and may select receipts for sharing as well as select one or more contacts or sharing profiles to share the receipt with. It will be appreciated that these steps need not be performed in a single order. For example, a customer may select a receipt and then indicate that that receipt needs to be shared within the receipts management software and select a contact or sharing profile to share the receipt with.

The electronic receipts software may allow the customer to select one or more receipts in different manners. For example, the software may allow the customer to select the last receipt for sharing. The software may allow the customer to select multiple receipts for sharing, such as selecting all receipts in a given time period for sharing.

In sharing a receipt, the customer may associate 108 additional information and sharing decisions with the receipt. Where a customer purchased multiple items in the same transaction, the customer may not want to share all of those items. The electronic receipts software may allow the customer to select a receipt and to select particular items on the items on the receipt for sharing. The customer may black list items on the receipt, indicating that those items should not be shared presently and should not be shared when sharing future receipts. This determination may also be made globally, such that certain items are not shared with any receipt sharing profile. The customer may white list certain items, indicating that those items are shared. Upon white listing items, the customer may determine that receipts containing those items are automatically shared with one or more sharing profiles, or that upon purchasing those items, the receipts management software may prompt the customer to share the receipt. According to these selections, the customer may share redacted versions of the receipts such that selected items appear on the shared receipt and other items do not. The customer may share a particular receipt with different sharing profiles differently; sharing different items on the receipt with different sharing profiles.

The electronic receipts software may allow a customer to establish many of these and similar preferences while creating the sharing profile associated with a particular person or group of people. For example, a customer may create a sharing profile where all receipts are shared with one or more persons associated with that profile. The customer may create a sharing profile where the electronic receipts software prompts the customer to share receipts with the persons associated with that profile. The customer may create a sharing profile where the electronic receipts software does not take action automatically and the customer must affirmatively share receipts with persons associate with the profile.

The customer may also use the electronic receipts software to associate additional information with particular items on the receipt. For example, the customer may enter budget reasons into the electronic receipts software and the software may save the entered information as data or metadata associated with the receipt. The customer may indicate that items were purchased for a party, for groceries, for a gift, etc. This may assist a customer who is sharing the receipt with a family member to help track expenses and manage a budget. The customer may also enter ratings, reviews, comments, etc. related to particular items on the receipt. The customer may enter a message to accompany the receipt. This information may be saved and associate with the receipt and, where appropriate, associated with particular items on the receipt.

According to one embodiment, the process 94 for sharing a receipt may often include the customer making a purchase 96 and receiving 98 an electronic receipt 74 on their mobile electronic device 68A. The customer may then enter 102 electronic receipts software on their mobile electronic device and select a receipt, items on that receipt, a sharing profile or contact to share that receipt with, etc. The customer may enter 108 additional information or sharing options as desired. The customer may then input a command to share the receipt with the sharing profile or contact. Sharing and receipt information is then sent 110 to a receipts management server 72. According to the customer's sharing profile and the additional information and selections selected by the customer, the receipt may then be processed 112 by the server 72 and the shared receipt is sent 114 to the person or persons associated with the sharing profile. A shared copy of the receipt and/or receipt information is sent to that person showing the desired items and information. A receipt may often be shared by sending a notification to the person (i.e. to the persons mobile electronic device 68B) that the customer has shared a receipt with them, allowing the person to accept or block the shared receipt, and delivering the receipt information if the person has accepted the receipt.

The electronic receipts software may send 110 the information associated with sharing the receipt from the mobile electronic device 68A to a receipts management server 72. In one embodiment, the mobile electronic device may transmit the information to the server 72 over its own network. The server 72 may then process 112 the receipt sharing request. In processing the receipts sharing request, the server may receive receipt identification information to identify the particular receipt/transaction. The server would also receive the information associated with sharing the receipt, such as the contact information for the person who will receive the shared receipt and the customized information associated with the sharing profile and that a customer may have entered in association with the particular receipt.

The server 72 may then process the information to provide this information in a manner which is useful. The server may create a version of the receipt for sharing which includes the additional item and receipt associated information. This information may be provided in varying formats according to the delivery of the shared receipt information. Information associated with a particular item may be printed or shown on a receipt image next to that item.

The server 72 may modify the receipt or the receipt information to make the receipt more useful for the person who receives the shared receipt. By way of example, the server may modify the items listed on the receipt to show a more complete item description to make it clear to the contact person what the items are, what the item and package quantity is, etc. The shared copy of the receipt may be modified to remove payment information from the receipt, such as by removing credit card information from the receipt. In some cases, the customer may select to share the payment information, such as when sharing a receipt with a family member to track expenses. The server may also modify the receipt to limit the use of the shared receipt. For example, the receipt may be modified to include a modified machine readable code 76 (i.e. the transaction identification number) which indicates that the receipt cannot be used for returns. The receipt may also be modified to print on the shared copy of the receipt that the receipt cannot be used for returns.

The server 72 may also modify the receipt or append additional information to the transmitted receipt to indicate the customer identity. The server may include the name, telephone number, and/or email address of the customer who is sharing the receipt. When the customer is selecting a receipt for sharing, the electronic receipts software may include tick boxes or prompt the customer to indicate if they desire to share their name, telephone number, email, etc. Alternatively, the customer may provide these selections when creating a sharing profile so that the desired information is provided to those persons associated with the sharing profile.

After preparing the shared receipt the server 72 may then transmit 114 the shared receipt to the person or persons associated with the sharing profile created by the customer. The server 72 may use communications devices such as a modem to transmit the receipt via email to the contact person. The server may use other communications devices according to the delivery method, such as delivering the shared receipt to a mobile electronic device 69B via the device communications network. The shared receipt may then be received by the contact person associated with the receipt sharing profile and that person may utilize the receipt as desired.

The system may be set up such that an identity used to identify the customer and the person or persons with whom receipts are shared may be a registered email address, a mobile phone number, or a unique username or user ID. This identity may be entered when the customer or person creates an account with the receipts management server 72 through use of the receipts management software. This identity may be used by the server 72, along with additional information associated with the identity and account to deliver shared receipts. Each of the persons involved with sharing a receipt may receive an authentication/notification key which is stored within their mobile electronic device. When the device is powered on, or when the receipts management software is active, the device may use the key to request new or updated receipts from the server.

If desired, shared receipts may also be modified or updated by persons with whom the receipt was shared as well as by the customer. Thus, any of these persons may add comments, ratings, reviews, etc. to items on the shared receipt. These comments may then be associated with the receipt and be shared with the other persons who have the receipt. Thus, comments added by a person who received a shared receipt may be transmitted back to the customer. All shared copies of the receipts may be updated in this manner. Similarly, if the customer returns an item on the receipt, the shared copies of the receipt may be updated to show that the item was returned. In this manner the electronic receipts software may, through receipt sharing, combine information and data from different users. These users may be associated with each other, such as being family or friends. The software may thus provide a medium for these persons to share comments and information with each other. In this manner, the electronic receipts software may allow persons to easily share receipts within a group as well as easily share additional related information associated with the receipts.

The comments, reviews, ratings, and other information provided between the customer and other persons who have received a shared copy of the receipt may be provided to the server 72 and may be used as product feedback by the store to assess customer satisfaction with the purchased items.

The customer may remain the owner of a receipt even after sharing the receipt. If the customer decides that a receipt was shared in error or should no longer be shared with a person or persons, the customer may revoke the shared receipt. When the person next opens the electronic receipts software, the server 72 may remove the shared receipt information from the mobile electronic device.

Sharing the receipt with other persons may provide a functional receipt to the persons and may allow the contact persons to perform additional functions with the receipt. The other persons may perform returns with the receipt. This may, for example, allow a spouse or other closely associated person to return an item. In such a system configuration, sharing a receipt provides authorization to the sharing contact persons. In such a configuration, there may be restrictions to making returns from a shared receipt. The recipient of the shared receipt might be able to make a return but the purchase price might be credited back to the credit card used by the customer to purchase the item. The customer might be able to make a return but they may be limited to a few options such as a subset of options of how the original purchaser could have handled a return. If the original customer could return an item for a refund, store credit or exchange the shared recipient might be able to return the item for store credit or exchange. If the original customer could return an item for store credit or exchange, the shared receipt recipient might be able to return the item for exchange.

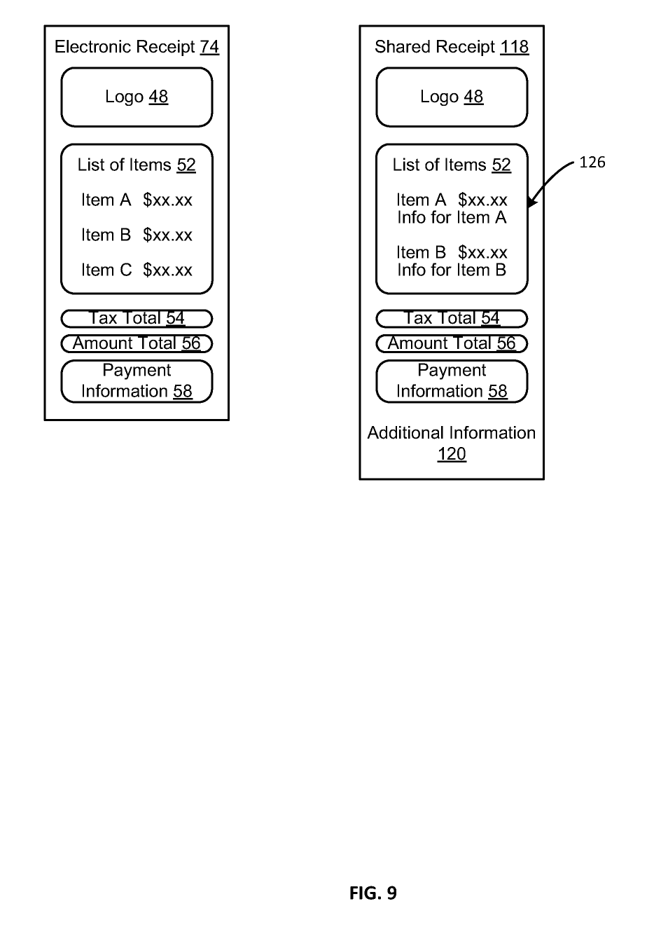

Referring to FIG. 9, receipts which have been shared according to the present system are shown. An electronic receipt 74 may have been obtained by a customer who has elected to receive electronic receipts. The customer may desire to share this receipt as discussed. Accordingly, a shared copy 118 of the receipt may be sent to one or more other persons. Additional information 120 and additional item information 126 may be created and shared with the person(s) associated with the sharing profile created by the customer. As discussed, additional information may be also be provided back to the customer and each copy of the receipt may be updated to reflect all additional information.

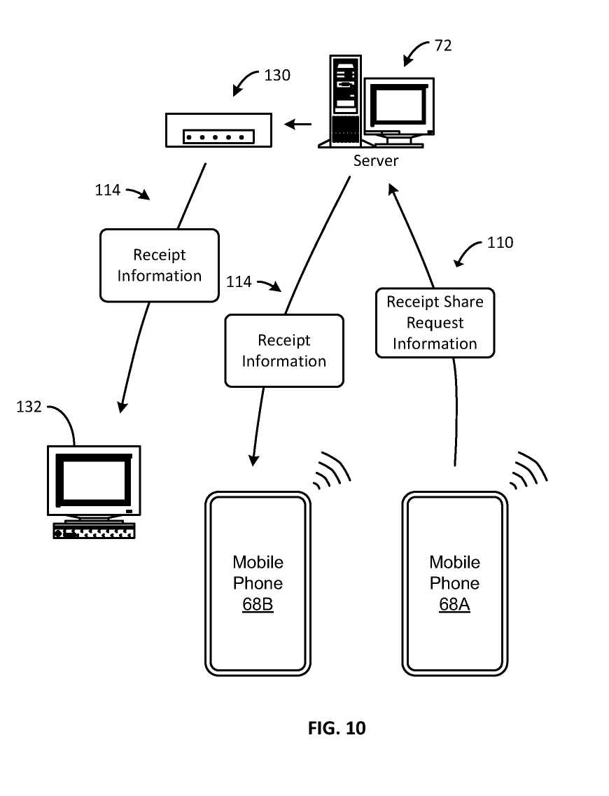

Referring now to FIG. 10, an exemplary general flow of information for sharing receipts is shown. The mobile electronic device 68A will typically send 110 receipt information to a server 26, 34, 72 over the mobile electronic device network. The receipt information will contain the information necessary to request sharing the receipts and will contain any information necessary for modifying the receipt or sharing the receipt with associated additional data.

The server 26, 34, 72 may then process 112 the receipt sharing request and prepare the receipt information and associated information in the desired format. When the server has completed any necessary processing of the receipt and associated information, the server may use a communications device 130 to send 114 the shared receipt information to the desired person. The server may typically send 114 the receipt data to a mobile electronic device 69B such as a mobile telephone. If desired, the server may send the receipt information to a computer 132 as indicated by the customer; typically by making such an indication in the stored information associated with the sharing profile. The receipt information may be sent to a computer 132 via email, a web browser, through a specific sharing program which may form part of the electronic receipts software, etc.

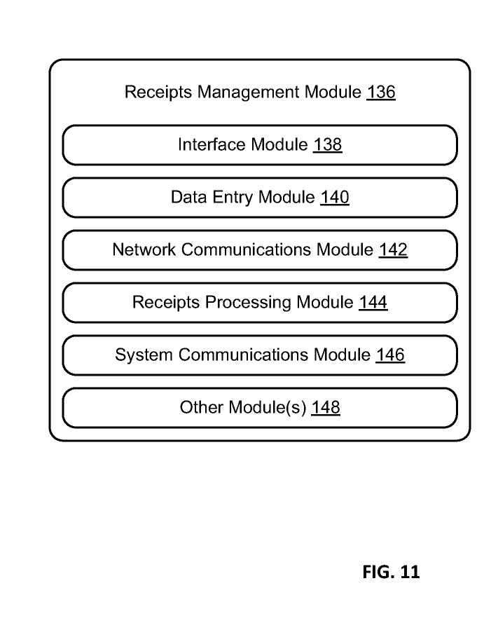

Referring to FIG. 11, a computer system may include a receipts management module 136. The various functions or modules of a receipts management module 136 may be enacted or implemented by any suitable system or component thereof. For example, in selected embodiments, one or more functions or modules of a receipts management module 136 may be distributed across one or more hardware devices, including a mobile electronic device 68A, 68B, a primary computer 12 of a POS system 10, a local server 26, a supervisory server 34 or 72, some other onsite resource, some other offsite resource, or the like or combinations or sub-combinations thereof. Thus, different embodiments may be adapted to a wide variety of situations, including more rigid legacy systems.

In selected embodiments, a receipts management module 136 facilitates the receipts printing process described herein. The receipts management module may include any suitable arrangement of sub-components or modules. The receipts management module 136 may include an interface module 138 which interfaces with a customer. The interface module may include a display on a mobile electronic device 68A, 68B. The receipts management module 136 may also include a data entry module 140 which may include a keypad or touchscreen on a mobile electronic device 68A, 68B and which allows the customer to enter data associated with a receipt sharing profile or with a particular receipt or item on the receipt. The receipts management module 136 may include a network communications module 142 which may facilitate communications between the mobile electronic device 68A, 68B and the server 26, 34, 72.

The receipts management module 136 may include a receipts processing module 144 which may include a server 72 and which may facilitate processing receipts and preparing receipts for sharing. The receipts management module 136 may include a system communications module 146 which may communicate between a server 26, 34, 72 and one or more persons associated with a receipts sharing profile, such as by way of a mobile electronic device 68B or a computer 132 associated with that person. The system communications module may include a communications device 130 and may transmit receipt information from the server to the contact person. The receipts management module 136 may also include other modules 148 as are desirable to implement various embodiments. The various modules and parts of the mobile self-checkout module 136 may include both hardware, firmware and software components as are desirable for various embodiments and to achieve the various steps, features, and functionality discussed herein.

The flowchart and block diagrams of the Figures illustrate the architecture, functionality, and operation of possible implementations of systems, methods, and computer program products according to one or more embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figure. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. At a mobile electronic device, the mobile electronic device including a processor and system memory, a method for sharing an electronic receipt, the method comprising the processor:
initiating electronic receipts software at the mobile electronic device in response to a user command from a user;
accessing an electronic receipt at the mobile electronic device, the electronic receipt having been received from a Point-of-Sale system during a sales transaction, the electronic receipt including a plurality of receipt items, each receipt item corresponding to a product purchased during the sales transaction;
receiving a user selection of a contact person at the mobile electronic device;
receiving a user indication to share the receipt with the contact person;
accessing rules previously entered by the user, the rules corresponding to a sharing profile associated with the contact person, the previously entered rules defining receipt items that are permissible to share with persons on the sharing profile and defining receipt items that are not be shared with persons on the sharing profile;
identifying a subset of receipt items, from among the plurality of receipt items, to share with the contact person based on the previously entered rules; and
sending the subset of receipt items to a receipts management server so as to cause the receipts management server to electronically share a copy of the subset of receipt items with another mobile electronic device associated with the contact person;
wherein both the user and the contact person have accounts with the receipts management server.

2. The method of claim 1, wherein sending the subset of receipt items to a receipts management server comprises the mobile electronic device sending the subset of receipt items to the receipts management server over a wide area communications network.

3. The method of claim 1, wherein sending the subset of receipt items to a receipts management server comprises:
sending information to identify the electronic receipt to the receipts management server; and
sending information to identify the contact person to the receipts management server.

4. The method of claim 1, further comprising receiving additional user entered information that is to accompany the one or more portions of the electronic receipt sent to the contact person.

5. The method of claim 1, wherein receiving a user selection of a contact person comprises receiving a selection of the contact person from a contact list.

6. The method of claim 1, wherein receiving a user selection of a contact person comprises receiving a selection of the contact person from contacts stored at the mobile electronic device.

7. The method of claim 4, wherein the rules previously entered by a user includes rules including one or more of: a black list of items that are not to be shared with the contact person and while list of items that are to be shared with the contact person.

8. The method of claim 4, wherein receiving additional user entered information that is to accompany the one or more portions of the electronic receipt comprises receiving information which is specific to an item of the electronic receipt.

9. The method of claim 8, wherein the information is selected from the group consisting of comments, reviews, and ratings.

10. The method of claim 4, wherein receiving additional user entered information that is to accompany the one or more portions of the electronic receipt comprises receiving information from the contact person which is specific to an item on the electronic receipt.

11. The method of claim 1, further comprising the receipts management server updating the shared copy of the receipt to reflect a returned item upon the customer returning an item listed in the electronic receipt.

12. The method of claim 1, further comprising allowing the contact person to make a return from the shared receipt.

13. The method of claim 12, further comprising allowing the contact person fewer return options than would have been available to the customer.

14. At a computer system, the computer system including a processor and system memory, a method for sharing portions of an electronic receipt among a plurality of mobile electronic devices, the method comprising the processor:
receiving a communication from a mobile electronic device, the communication including a plurality receipt items from one more or electronic receipts stored at the mobile electronic device and a sharing determination, the sharing determination requesting that a first one or more of the plurality of receipt items be shared with a first contact person and requesting that a second different one or more of the plurality of receipt items be shared with a second different contact person, the first one or more receipt items for the first contact person and the second different one or more receipt items for the second different contact person identified based on a sharing rules for a customer, the sharing rules defining how different receipt items are to be shared with a plurality of different persons, the first contact person and the second different contact person included in the plurality of different persons;
sharing the first one or more receipt items with another mobile electronic device associated with the first contact person; and
sharing the second different one or more receipt items with a further different mobile electronic device associated with the second different contact person;
wherein the customer, the first contact person, and the second contact person have accounts at the computer system.

15. The method of claim 14, further comprising:
receiving additional user entered information that is to accompany at least one portion of the electronic receipt when shared; and
sharing the additional user entered information with at least one of the other mobile electronic device and the further different mobile device in accordance with the sharing profile.

16. The method of claim 15, further comprising:
receiving an indication from the customer that the electronic receipt is no longer shared with the second different user; and
removing the second different one or more portions of the electronic receipt from the further different mobile electronic device in response.

17. The method of claim 15, wherein receiving additional user entered information that is to accompany at least one portion of the electronic receipt when shared comprises receiving one or more of: comments, reviews, and ratings specific to an item included in the electronic receipt.

18. The method of claim 14, further comprising:
receiving additional information from the second different contact person regarding an item on the electronic receipt; and
propagating the additional information back to the mobile electronic device.

19. The method of claim 14 further comprising:
receiving a selection of an item on the electronic receipt from the mobile electronic device; and
modifying the selected item based on receiving the item selection.

20. The method of claim 14, further comprising:
sharing a modified copy of the item with one or more of the other mobile electronic device and the further different mobile electronic device based on the sharing determination.
